(19) United States
(12) Patent Application Publication
(10) Pub. No.: US 2016/0341064 A1
(43) Pub. Date: Nov. 24, 2016

(54) POWER GENERATOR, SYSTEM AND METHOD

(71) Applicants: Gregory Samaras, Whitestone, NY (US); Menelaos Tzilvelis, Whitestone, NY (US)

(72) Inventors: Gregory Samaras, Whitestone, NY (US); Menelaos Tzilvelis, Whitestone, NY (US)

(21) Appl. No.: 15/158,266

(22) Filed: May 18, 2016

Related U.S. Application Data
(60) Provisional application No. 62/163,165, filed on May 18, 2015.

(51) Int. Cl. F01D 15/10; F03B 13/10; F03B 3/06

(52) U.S. Cl. CPC F01D 15/10; F03B 3/06; F03B 13/105; F05D 2220/76; F05D 2240/91

(57) ABSTRACT

A system and method for generating hydroelectric power using the plumbing and water distribution system of a new or existing structure, wherein said system includes a source of potable water, at least one pump placed in fluid communication with the source of potable water, wherein the at least one pump includes a fluid discharge output, a water distribution pipe connected to the fluid discharge output of the at least one pump, a turbine having at least one rotating blade and a turbine housing concealing the turbine, connected to the water distribution pipe.

### CROSS-REFERENCE TO RELATED APPLICATIONS

This application claims the benefit and priority to U.S. Provisional Application No. 62/163,165 filed May 18, 2015, and entitled “Power Generator, System and Method.”

### FIELD OF THE DISCLOSURE

The following relates to a system and method for generating power, and more specifically, a system and method for utilizing the plumbing and water distribution system of a new or existing structure to generate additional power and store the generated power until needed.

### BACKGROUND

High-rise buildings decorate the landscape of our major cities across our great nation. Not only are these buildings a challenge to build architecturally, but there are also many challenging factors that must be considered when these buildings are engineered and ultimately constructed. The challenges faced not only include supporting the general structure of the building to be constructed, but also include efficiently engineering modern comforts, such as indoor plumbing and supplying water throughout these large buildings. Plumbing design and supplying water from the first floor to the top floor is one key aspect that must be carefully considered during the construction of these buildings. If these buildings are going to be inhabitable there must be a steady supply of water to fulfill every day uses such as drinking and bathing, as well as mechanical uses such as cooling towers and HVAC equipment.

Current methods for supplying water and distributing it throughout high-rise buildings consume large amounts of energy. Typical construction and engineering solutions for supplying water utilize pressurized pumping systems to transport the water from a water main through the existing plumbing and into one or more storage tanks. Due to the size of the storage tanks, these tanks most often are constructed on the roof of the high-rise, while the water main may be accessible from ground level or underground. Accordingly, the pumping system for the high rise must expend large amounts of energy to move the water from the water source to these storage tanks.

Hydroelectric energy conversion systems are desirable as an alternate method for generating electrical power. The systems can convert the kinetic energy from flowing water into electrical energy that may be stored for later use by residential and commercial systems. However, current hydroelectric systems are incapable of being installed or retrofitted into existing water pipes. Instead, the water must be diverted to separate power generation location within the building before the water is ultimately diverted back to the desired destination. This diversionary method requires additional energy beyond the current energy requirements needed to pump the water to the storage tanks or top floor of the building. Therefore, a system and method are needed for generating hydroelectric energy to offset the energy requirements of pumping water throughout the high-rise building without imposing additional energy requirements that would result from further diverting the water to a generator, positioned at a separate interior or exterior location of the building.

### BRIEF SUMMARY

A first aspect of this disclosure relates to a method for generating hydroelectric power comprising the steps of providing at least one pump receiving a potable water source, connecting a water distribution pipe to the at least one pump, discharging from the at least one pump, a portion of the potable water source into the water distribution pipe, installing a turbine along the water distribution pipe, wherein the turbine includes at least one blade, a shaft and a generator, rotating the shaft and at least one blade of the turbine, producing mechanical energy and converting the mechanical energy into electrical energy using the generator.

A second aspect of this disclosure relates to a system for generating hydroelectric power comprising a source of potable water, at least one pump placed in fluid communication with the source of potable water, wherein the at least one pump includes a fluid discharge output, a water distribution pipe connected to the fluid discharge output of the at least one pump, a turbine having at least one rotatable blade connected to a shaft; a turbine housing concealing at least a portion of the turbine, connected to the water distribution pipe.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a schematic view of an embodiment of a water distribution system for a building;

FIG. 2 depicts a schematic view of an alternative embodiment of a water distribution system for a building;

FIG. 3 depicts a schematic view of a third embodiment of a water distribution system for a building;

FIG. 4 depicts a fourth embodiment of a water distribution system for a building;

FIG. 5a depicts an isometric sectional view of an embodiment of a turbine;

FIG. 5b depicts a sectional top view of an embodiment of a turbine connected to a water distribution pipe of a water distribution system;

FIG. 5c depicts a sectional front view of an embodiment of a turbine connected to a water distribution pipe of a water distribution system;

FIG. 6 depicts a sectional top view of an alternative embodiment of a turbine;

FIG. 7 depicts an exterior view of another alternative embodiment of a turbine connected to a water distribution pipe of a water distributions system;

FIG. 8a depicts a schematic view of an embodiment of a water distribution system including an embodiment of a turbine charging an electrical apparatus; and

FIG. 8b depicts a schematic view of an alternate embodiment of a water distribution system, including multiple turbines charging multiple electrical apparatuses.

### DETAILED DESCRIPTION

A detailed description of the hereinafter described embodiments of the disclosed apparatus, method, and system are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

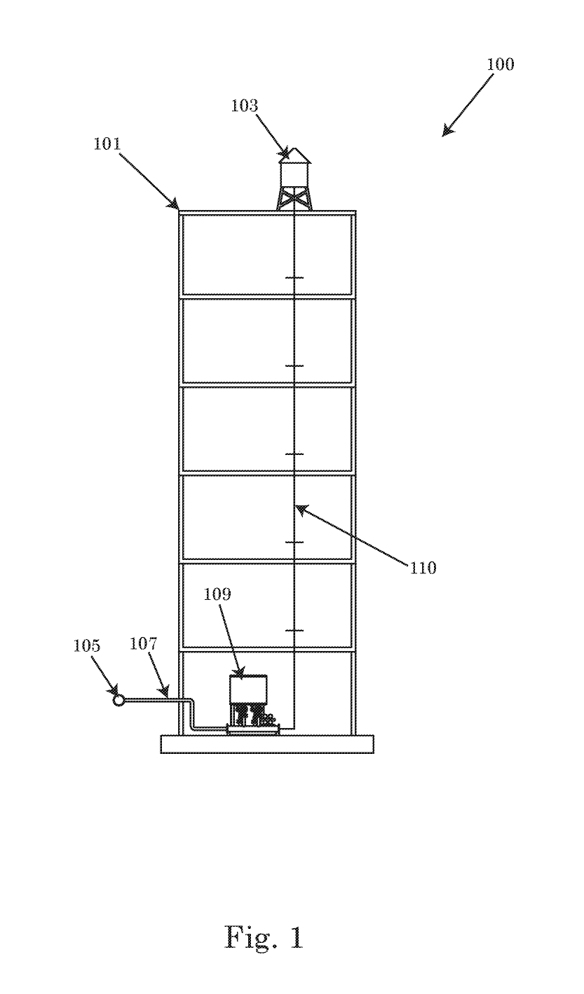

Referring to the drawings, FIG. 1 depicts an embodiment of a system 100 providing for the distribution of water to the interior levels of a building 101. A water distribution system, such as the embodiment of system 100, may be installed in any type of building 101, including both commercial and residential buildings. Examples of buildings 101 that may have a water distribution system 100 installed may include high rises, skyscrapers, towers, superstructures, factories, office buildings, industrial buildings, hotels or any other type of building that may have a particularly high elevation, may include many floors or stories, or may include multiple groups of individuals having residencies within the single building structure.

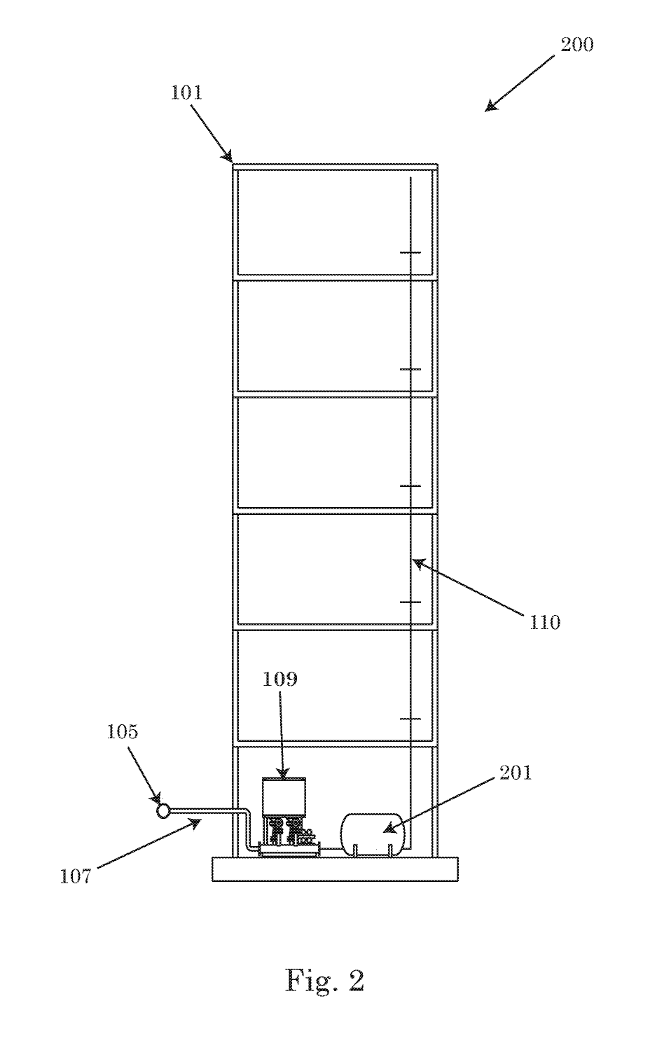

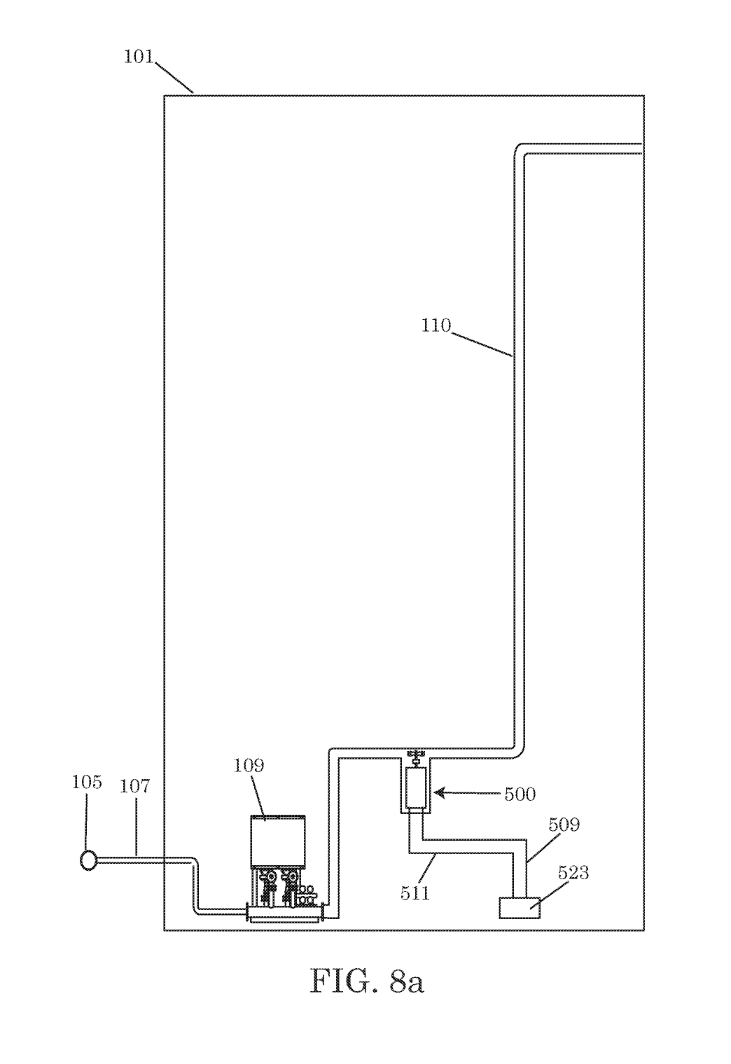

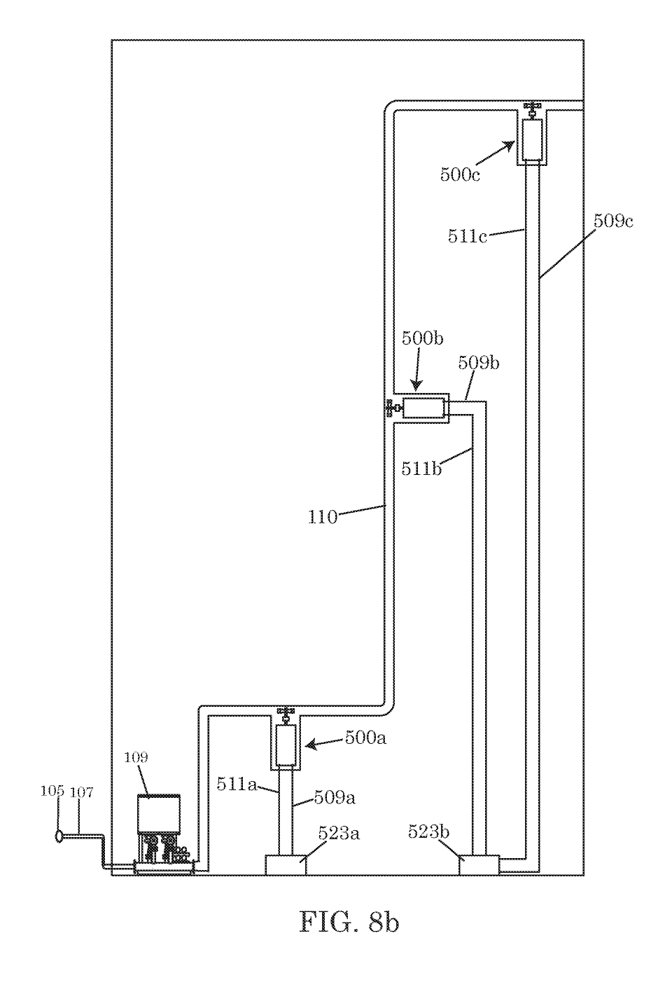

In some embodiments of the water distribution system 100, the system may provide a source of potable water from a water source 105 to the remainder of the building 101. In the exemplary embodiment provided in FIG. 1-FIG. 4 and FIG. 8a-8b, the water source 105 may be provided from a water main that resides outside of the building, such as a water hookup provided by the city or county where the building 101 may be located. In most large cities, the city itself may provide a water hookup through the city maintained water main. In alternative embodiments, the water source 105 may be provided from a source independent of the government run water supply. These independent sources of water supplies may include third party water suppliers, groundwater, wells, aquifers, springs, rainwater collection devices, surface water, an atmospheric water generator which may condense humid air into water and dryer air, desalinated salt water, such as from the ocean or any other known water supply. Embodiments of the water source do not necessarily need to reside outside of the building 101 itself. For example, in an embodiment that utilizes an atmospheric water generator, the apparatus may be located within the building itself, converting the humid air within the building to potable water which may subsequently be distributed throughout the building by the distribution pipes 110.

In some embodiments of the water distribution system 100, the system may further include at least one pump 109. The pump 109 may be placed in fluid communication with the source of potable water 105. Embodiments of the pump 109 may be utilized to draw potable water from the water source 105 and pressurize the water in order to distribute the water throughout the building 101. The pump 109 may include both an input receiving the water from the water source 105 and a fluid discharge output, for releasing the water from the pump 109 at a desired pressure, for distribution throughout one or more sections of the building 101. For example, in the exemplary embodiment, the fluid discharge output of the pump 109 may be connected to the water distribution pipes 110, allowing for the pump 109 to discharge the water received from the water source 105 into the water distribution pipes 110.

In some embodiments, the water supplied from the water source 105 may be required to be transported from the water source 105 to the pump 109 prior to being pressurized and distributed throughout the building. For example, in the exemplary embodiment, the pump 109 may be positioned in a section of the building, such as the first floor or basement, while the water source may be outside the building 101 or at an external location. In such an embodiment, the output of the water source 105 may be connected to the input of the pump 109 via a transport pipe, tubing, hose or other conduit 107 capable of transporting water from the water source 105 to the pump 109.

The type of pump 109 used in the system may vary from building to building or between different embodiments of the water distribution system. Generally, there may be two types of pumps 109 that may be used, a centrifugal pump or a positive displacement pump. A centrifugal pump may be identified as producing both a head and a flow by increasing the velocity of the liquid entering the pump, with the help of a rotating vane impeller. In some embodiments, the centrifugal pump may include radial, axial or mixed flow units. Embodiments of the centrifugal pump may further be classified as end suction pumps, in-line pumps, double suction pumps, vertical multistage pumps, horizontal multistage pumps, submersible pumps, self-priming pumps, axial-flow pumps or regenerative pumps.

Embodiments of a positive displacement pump on the other hand may be identified by the alternating or filling of a cavity and then displacing the volume of liquid therein. The positive displacement pump may deliver a constant volume of liquid for each cycle against a varying discharge pressure or head. A positive displacement pump may be further classified as a reciprocating pump, such as a piston, plunger or diaphragm pump, a power pump, a steam pump or a rotary pump, including gear, lobe, screw, vane regenerative (peripheral) and progressive cavity pump.

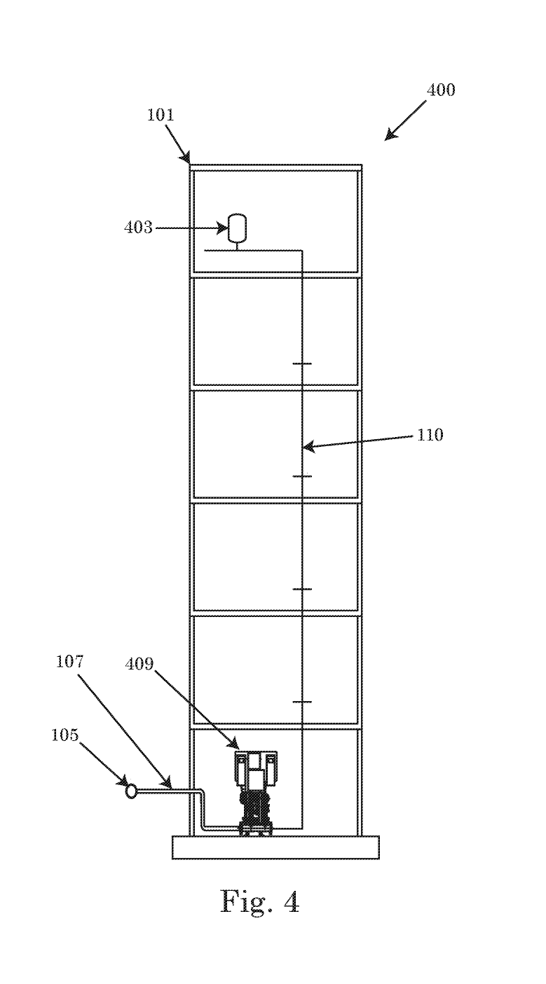

In the exemplary embodiments shown in FIG. 1-4, 8a-8b, one or more centrifugal pumps are depicted. The pump 109 may include a constant speed pump 109 and/or booster pump. In some embodiments, the constant speed or booster pump may be outfitted with a pneumatic tank 201. In the alternative exemplary embodiment depicted in FIG. 4, a variable speed pump 409 may be used, alone or in conjunction with a booster pump.

Referring back to FIG. 1, which depicts one embodiment for distributing water to every floor of building 101. This embodiment depicts a system and method of water distribution which may be used in existing buildings of various ages. The distribution system 100 depicted may include a constant speed pump 109 receiving water via the transport pipe 107 from a water source 105. The water entering the pump 109 may be pressurized and transported along a network of one or more water distribution pipes 110. The water ejected by the pump into the network of water distribution pipes 110, may be further stored in one or more storage tanks. In the exemplary embodiment, the tank 103 may be a roof-top water-tower. In some embodiments, the roof-top water tank 103 may be equipped with a float mechanism. The pump 109 and the storage tank may operate in conjunction with one another based on the water level of the float in the storage tank. As the level of the water in the tank 103 decreases below a specified level, the float may reach its minimum threshold. Once the float's minimum threshold level is reached, the pump may be activated and begin refilling the roof-top tank 103 until the float device reaches a predetermined level inside the storage tank. Once this predetermined level is reached, the pump may be switched off in order to prevent the pump from overfilling the tank.

Embodiments of the water distribution pipes 110 may vary in material based on the building manufacturer and the date in which the building 101 was constructed. In some embodiments, the network of water distribution pipes 110 may be constructed out of hard, rigid materials. These materials may include cast iron, galvanized iron, ductile iron, steel, non-cylinder concrete, reinforced concrete, pre-stressed concrete, asbestos cement, vitrified clay, polymer concrete, copper and in some old structures lead pipes may still exist. In other embodiments, the pipes may be less rigid or more flexible. These less rigid pipes may be constructed out of non-rigid plastics, tubing or hoses made out of materials such as polyvinyl chloride (PVC), high density polyethylene (HDPE), thermosetting plastics such as fiberglass-reinforced polymer (FRP), and corrugated steel pipes.

In some embodiments, the system 200 may further include or replace the roof top tank 103 with a pneumatic pressure tank 201. The pneumatic tank 201 may be used in conjunction with an air compressor to pressurize the water in the distribution pipes 110 without having to store the tank external to the building 101. The pneumatic tank 201 may eliminate several problems observed by the roof-top tank system, including the roof-top tank's need to keep the stored water heated during the winter and cooled during the hot summer months. While the pneumatic tank 201 may be advantageous in some regards, the pneumatic tank 201 may also be disadvantageous in some buildings because pneumatic tank systems 201 may require additional energy to power the pump at a constant speed despite low demand periods of the system 200, expensive equipment, and the need for a large space within the building to install and maintain the equipment.

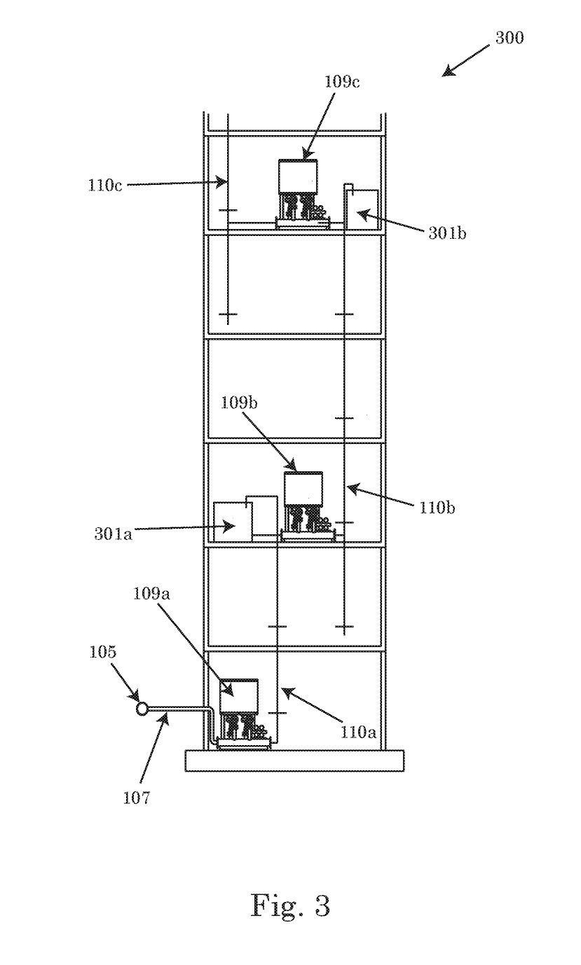

In some embodiments, the water distribution system may include one or more pumps 109a, 109b, 109c and/or one or more storage tanks 301a, 301b, holding potable water. Referring to FIG. 3, embodiments of water distribution systems may include various zones or regions wherein one or more pumps in that region may distribute water to the rest of the zone or region of the building or to the remaining portion of the building. As shown in the exemplary embodiment, each pump 109a, 109b, 109c may provide water distribution to one or more floors in the building 101. The spacing of the pumps may vary from region to region. As shown in FIG. 3, the first pump 109a may pressurize and provide water from the water source 105 to a plurality of floors, including the ground floor, the second floor or floors beyond the second floor. In some embodiments, the first pump 109a may further provide water from the water source to a tank 301a provided in fluid communication with a second pump 109b.

Subsequently, as shown, the second pump may operate to distribute the water in a similar fashion to the first pump. For example, the water received by the first tank 301a may act as a water source for the second pump 109b, in an analogous fashion to the water source 105 that feeds into the first pump 109a. In some embodiments the regions may overlap, wherein one of the plurality of pumps 109a, 109b, 109c service and distribute water to a plurality of floors, including in some embodiments, one or more floors that receive water from a prior or subsequent pump.

As shown in the exemplary embodiment, the second pump 109b situated on the third floor of the building may provide water to one or more floors below it as well as one or more floors above the second pump 109b. In the exemplary embodiment, the second pump's region overlaps with the first pump which also provides water to the second floor, as well as the third pump 109c. For example, in the embodiment shown, the second and third pump may both distribute water to the 5^{th} floor as well as the surrounding floors.

In addition to providing water to its region of the building, the second pump 109b, may further pressurize and supply water to a second water tank 301b in some embodiments. In such an embodiment, the second tank 301b may be fluidly connected to a subsequent pump, such as the third pump 109c depicted in the drawings. The subsequent or third pump 109c, may subsequently provide water distribution through water distribution pipes to a plurality of floors in the building, both above and below the pumps in each region.

In some embodiments, the constant speed pump depicted in FIG. 1-3 may be replaced with a variable speed pump in some systems 400. A variable speed pump 409 may be advantageous in some water distribution systems because of the ability to maintain a constant discharge water pressure throughout the system 400, regardless of the demand or flow of the system 400. The ability to maintain a constant pressure may be due to the variable speed pump's 409 ability to automatically adjust its speed to maintain a desired pressure. In some embodiments, a system equipped with a variable speed pump may further include one or more buffer tanks 403 which may compensate for one or more rapid changes in pressure of the overall system based on the changes in the variable speed pump's speed or demand for the water in the system. The buffer tank may limit the overall changes in the pressure of the system and distribution pipe 110 at the point of distribution, such as at a faucet, spigot, or shower head. The buffer tank 403 may compensate for the brief but drastic changes in pressure that may result during the course of normal use by occupants of the building in order to limit any noticeable effects of any sudden change in pressure.

In some embodiments of the water distribution system, where the water source may lacks sufficient or desirable water pressure, or in an instance where the particular building 101 experiences a decrease in water pressure due to the size or elevation of the building, the water distribution may be further outfitted with a booster system. A booster system may be used to compensate for the loss of pressure between the floors of a high rise building and the water source. For example, pressure will decrease for every additional floor in a high-rise or other tall building due to the distance between the water source and the destination. This loss in pressure may be accompanied by friction losses and vertical losses (static head). The booster system may be able to raise the water pressure at one or more points along the distribution pipeline, where the booster system is installed. For example, a booster system in a high rise building may be installed higher up in a building to prevent floors closer to the roof from experiencing unacceptable amounts of water pressure. For instance, if a building has 30 floors and the water source at the ground has a pressure of 250 psi, but the water pressure at the 25^{th} floor drops to approximately 20 psi, a booster may be installed to provide floors 25 to 30 with a more acceptable pressure, such as water pressure between 40-60 psi.

In some embodiments of the water distribution system 100, 200, 300, 400, the system may further include a plurality of one or more turbines 500 to generate hydroelectric power. The turbine 500 may be used to recuperate or offset the costs and energy requirements needed for pumping water to tall, high-rise buildings by utilizing the flow of the water, as it is provided by the pumps, in the water distribution system to generate electricity. Some embodiments of the systems described herein may provide between 1-100% of the electrical power consumed by at least one pump. In some embodiments the system may produce >1%, >5%, >10%, >20%, >35%, >50%, >75%, >80% or >95% of the electrical power consumed by the at least one pump in the system. The amount of electrical energy produced and consumed will vary depending on the size of the building and the configuration of the system recuperating electrical energy from the flow of the water through the water distribution pipes. In other embodiments, the amount of electrical energy produced may be between 10-100%. 1-25%, 25-45%, 45-65%, 65-75%, 75-90% or 90-100% of the electrical energy consumed by one or more pumps present in the water distribution system.

The turbine 500 may be designed in such a manner that it may take advantage of the water being pumped upward through the distribution pipes into the storage tank 103 in order to convert the water's kinetic energy into electrical energy. In some embodiments, wherein the pump 109 is pumping water from the ground floor to the roof, these embodiments may require an extraordinary amount of energy to raise the water several stories high in order to store or distribute it. According to basic fundamental principles of energy, once the water is raised to the rooftop that energy may be stored as potential energy, until the water stored in the rooftop tank is subsequently moved throughout the distribution pipes. Subsequently, the turbine 500 may further take advantage of the potential energy stored in the rooftop tank by generating additional electrical energy as the water flows from the roof-top tank downward through the distribution pipes to the system output, such as a faucet, spigot, shower head, or appliance.

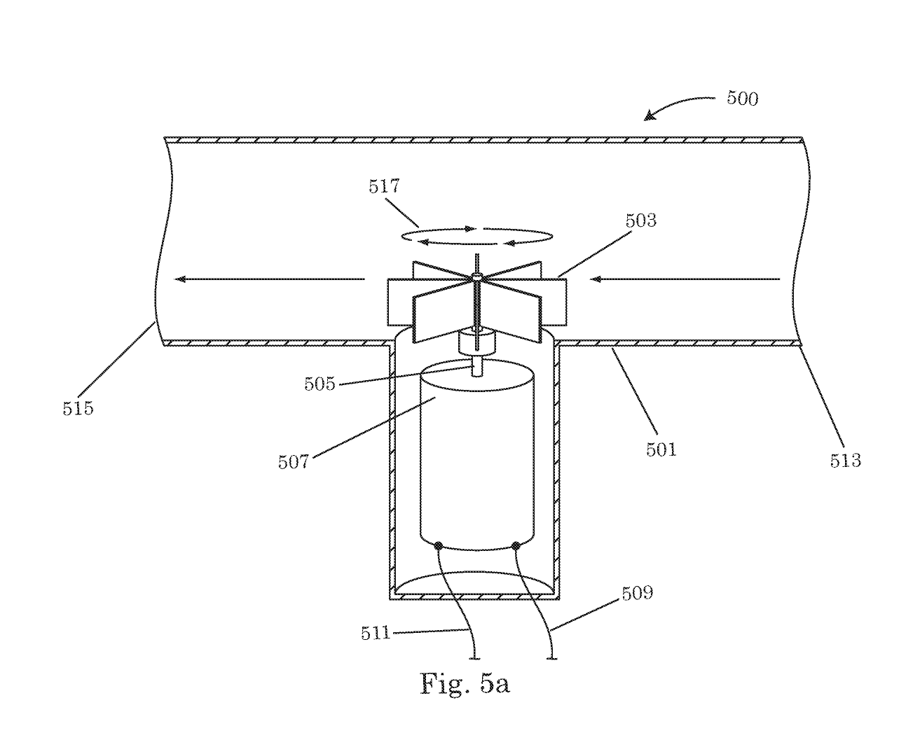

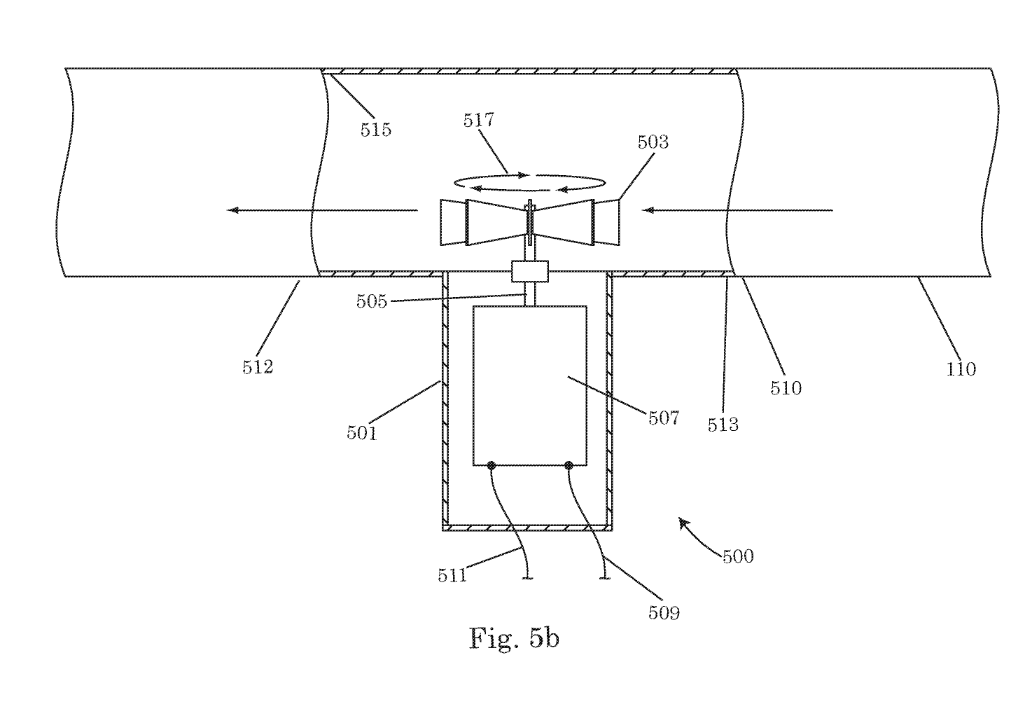

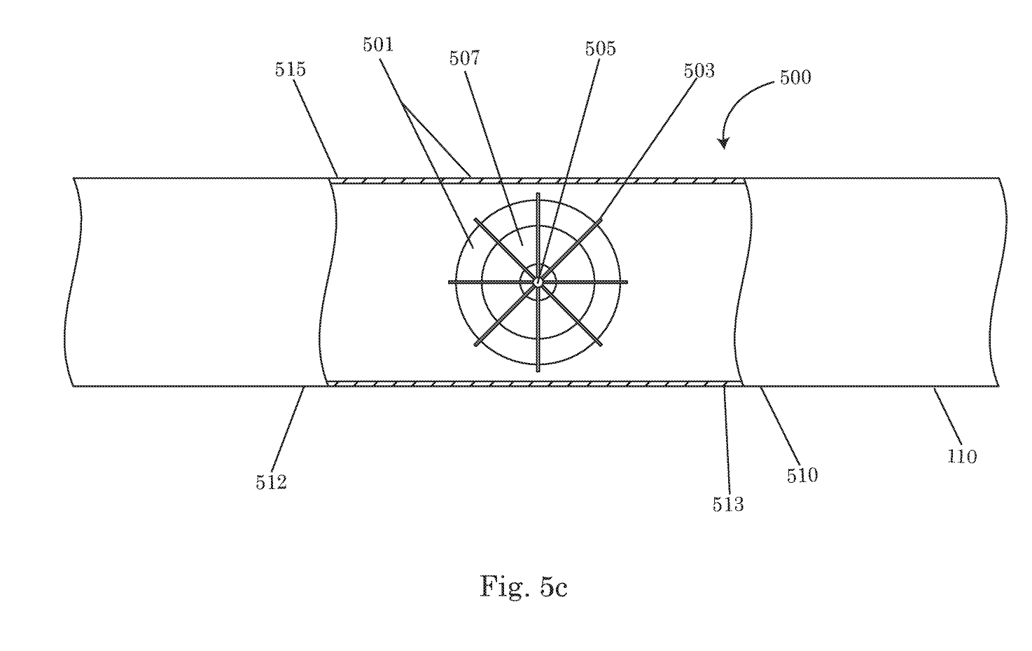

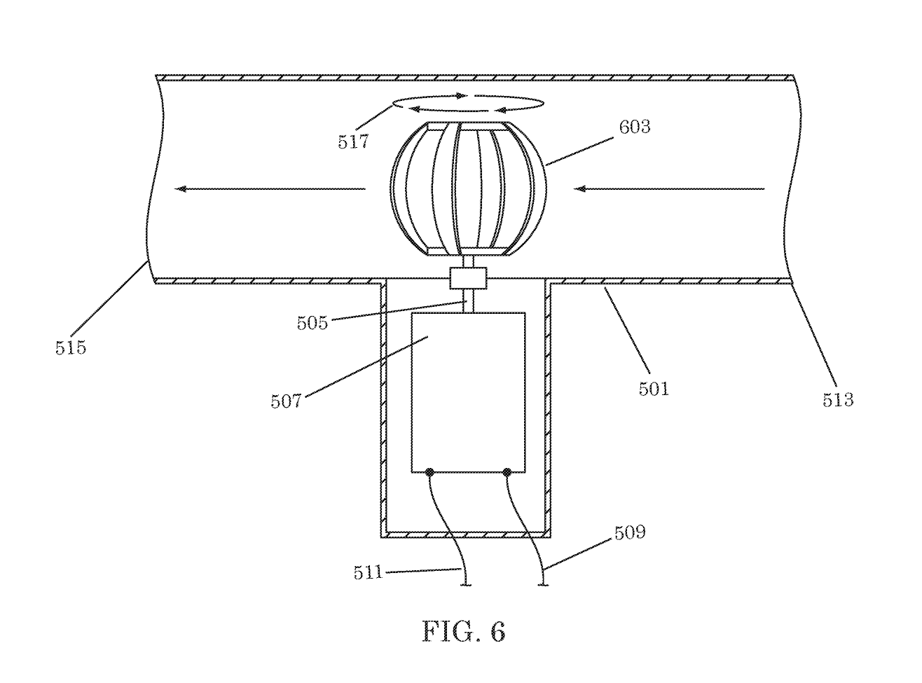

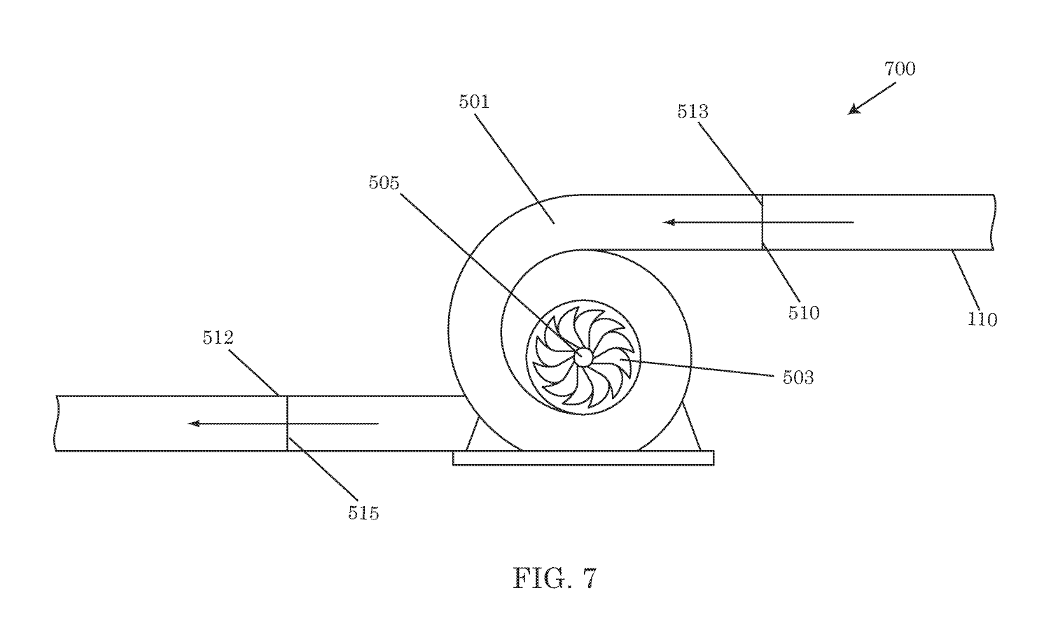

Embodiments of the turbine 500 may include a rotatable impeller or a rotatable propeller, which may contain one or more blades 503, depending on the type of turbine used in the system. In the exemplary embodiment, the impeller or propeller may include a plurality of blades. The shape and type of blades associated with the turbine may vary from embodiment to embodiment depending on the type of turbine being used. For example turbine 500 is depicted in FIG. 5a as flat paddle shaped blades whereas the embodiment of the turbine depicted in FIG. 6 includes curved, round shaped blades 603 positioned around a globe-shaped impeller. Embodiments of the turbines described and the turbine blades described may be interchangeable with those discussed throughout this application. For example, where the reference refers to rotatable blades 503, this may also include alternative embodiments of the rotatable blades, for instance those shown in FIG. 6 represented by blades 603 or FIG. 7 which depicts yet another embodiment of a turbine, a Francis turbine.

In some embodiments, the rotatable blades 503 may be attached or connected to a shaft 505. The shaft 505 may allow for the one or more blades to rotate in response to a force provided by the water flowing through the distribution pipe 110. The direction of the radial movement that may occur may depend on the orientation of the blades, and the shaft 505 relative to the flow of the water or other fluid. An example of this is provided in FIGS. 5a-5b, 6 and 7 which provide arrows indicating an example of the direct of the water flow through the pipe and the subsequent rotation 517 of the shaft and blades.

In some embodiments, the blades may be moved radially in a clockwise rotational manner in order to generate electricity. In an alternative embodiment, the blades may rotate the shaft 505 in a counterclockwise fashion to generate electricity. In the exemplary embodiment, the blades 503 may be capable of multiple rotational movements in response to the flow of water in the distribution pipe 110. For example as the water is pumped from the ground floor to a roof-top storage tank, the blades may rotate in response to the upward movement of the water, from the pump towards the tank, thus generating electricity. Conversely, as the water is released from the tank, and the water may flow downward through the network of distribution pipes 110, as it leaves the rooftop tank, the blades may rotate the shaft 505 in the opposite direction from when the water was initially supplied to the tank 103 in order to take advantage of the water flow from the tank 103 to generate more electricity.

Embodiments of the turbine 500 may further include a hydro turbine generator 507. In some embodiments, the generator may be attached to the shaft 505 of the turbine. The generator 507 may receive and connect to the shaft 505, which may be operably connected to one or more blades 503. In some embodiments, the turbine's generator 507 may convert the mechanical energy used to rotate the blades and shaft using the energy provided by the water source 105 being pumped through the distribution pipes 110, into electrical energy. A portion of the energy provided by the flowing water of the water source 105 may be transferred to the blades 503 of the turbine 500, causing the blades 503 to rotate 517. The mechanical rotation of the blades 503 and shaft 505 of the turbine may provide mechanical energy to the generator 507. Subsequently, the mechanical energy provided to the generator 507 may be collected and converted into electrical energy.

Embodiments of a hydro-powered turbine may include, but is not limited to, impulse turbines and reaction turbines. Examples of an impulse turbine may include a pelton turbine or a cross-flow turbine. Reaction turbines on the other hand may include propeller turbines such as a bulb turbine, straflo turbine, tube turbine or Kaplan turbine. Other embodiments of reaction turbines may further include a Francis turbine or a kinetic energy turbine.

In some embodiments, the electrical energy produced by the turbine 500, and more specifically the generator 507 may be further transported, stored, redistributed or used by electrical energy consuming appliances. The turbine 500 may include one or more electrical outputs 509, 511 which may be fed into or connected with the electrical power supply of the building 101 in some embodiments. For example, the turbine 500 may include a plurality of positive or negative electrical conduits capable of carrying the electrical energy, such as wires 509, 511. The electrical conduits may transport the electrical energy produced by the turbine and recombine the electrical energy with the building's power supply.

In an alternative embodiment, the turbine 500 may transport and store the electrical energy produced by generator 507 in one or more batteries 523a, 523b. The one or more batteries may be configured as part of a battery bank circuit and connected to the generator 507 in some embodiments. In other embodiments, the generator 507 of the turbine may be placed in electrical communication with at least one battery by providing an electrical conduit 509, 511, such as one or more wires 511a, 511b,511c, 509a,509b,509c connecting the one or more batteries 523a, 523b to one or more generators 507. Embodiments employing one or more batteries may allow for the storage and aggregation of the electrical energy. The storage of the electrical energy in one or more batteries 523 may allow for the electrical energy to be accessible at any desired time, such as during an emergency, or it may allow for the appliances of the building to consume the electrical energy produced in specified amounts as needed.

In some embodiments wherein more than one battery is present, the batteries may be wired in series with one another. In alternative embodiments, the batteries may be wired in parallel to one another or in a combination of both series and parallel. The types of batteries that may be used in the embodiments of the system may include, but are not limited to lithium, nickel or cadmium based batteries, deep cycle batteries, flooded type batteries such as a lead acid battery, sealed gel batteries, sealed valve regulated lead acid batteries, absorbed glass mat battery or a combination of batteries thereof. Embodiments of batteries may have a storage capacity between 7 Ah and 10000 Ah per cell. Suitable batteries in may include storage capacities in each cell ranging from 7-40 Ah, 36-265 Ah, 60-330 Ah, 190-4600 Ah, 240-3500 Ah, 265-3900 Ah, 200-6000 Ah, 400 Ah-8000 Ah, or 500-10000 Ah.

In some embodiments where multiple turbines 500a, 500b, 500c are positioned throughout the water distribution network of pipes 110, each turbine may have its own battery bank that the turbine may supply with electrical energy. In alternative embodiments, one or more turbines may supply electrical energy to a common battery bank having one or more batteries. In yet another alternative embodiment, multiple battery banks may positioned either in a single location or in multiple locations throughout the building. In such an embodiment, each battery bank may receive electrical energy from one or more turbines 500. To cut down on the overall transporting of the electrical energy to the battery banks, the building may be divided into regions based on a turbines' proximity to a battery bank. Accordingly, the one or more turbines in each region may supply electrical energy to the designated battery bank for the regions. Each building may have multiple regions, wherein each battery bank receives its electrical energy from a different set of one or more turbines.

In some embodiments of the battery bank circuit, the circuit may be equipped with a charging controller. The charging controller may have a positive and negative terminal for receiving a positive wire or electrical conduit 509 from the generator 507 and a negative terminal for receiving a negative wire or electrical conduit 511. The charging controller may limit the electrical current that is added to, or withdrawn from the one or more batteries 523 of the battery bank. The charging controller may prevent overcharging the batteries or the controller may protect against oversupplying a voltage to the batteries, thus maximizing the performance and lifespan of each battery 523. In some embodiments, the controller may act as a low voltage disconnect, whereby instead of charging the battery, the energy may be shunted back to the power supply feeding the remainder of the building 101 or one or more electrical appliances or apparatuses attached to the circuit. Using the charging controller as a low voltage disconnect may prevent additional energy from being stored in one or more fully charged batteries, allowing for the energy collected to be sent directly to any electrical appliances and apparatuses consuming the energy. Furthermore, the charging controller may also prevent electrical appliances or apparatuses drawing power from the battery bank circuit from overdrawing electrical energy or completely draining the batteries.

Embodiments of the battery bank circuit may further include a positive output terminal and a negative output terminal. Each of these output terminals may direct the electrical energy to the desired location. For example, the terminals may feed the electrical energy created by the turbine back to the main power supply of the building 101 in some embodiments. In other embodiments, the terminals may be directly connected to one or more electrical appliances or apparatuses. Each of the electrical terminals may receive electrical energy directly from the turbine itself in some embodiments, while in other embodiments, the electrical energy received may be directed to the terminals by the charging controller. Moreover, in some embodiments, the electrical energy may be provided from one or more storage batteries 523.

The electrical energy that may be presented at the output terminals of the battery bank circuit may be in the form of direct current (DC) in some embodiments. In an embodiment where alternating current (AC) may be the desired output of the battery bank circuit, embodiments of the battery bank circuit may further include an inverter. In an embodiment including an inverter, the DC current produced by the turbine may be transmitted to the output terminals of the battery bank circuit. Each of the output terminals may be connected to an inverter, wherein the electrical energy passes from the output terminal and enters the inverter, converting the DC current to AC current prior to the redistribution of the electrical energy to the desired location.

In some embodiments, the turbine and/or its housing may be pre-sterilized before being installed or connected to a water distribution pipe which may carry potable water such as drinking water. In other embodiments, the turbine and/or its housing may contain a self-sterilization system in order to prevent microbial buildup or other contaminants from forming along the turbine, its components or its housing. Embodiments of the self-sterilization system may include connecting UV generating lights or lamps along the turbine, its housing or components. In some embodiments, the UV lights or lamps attached along the turbine, its components and/or its housing may be powered by the turbine itself via the hydroelectric energy produced by the generator. In some embodiments, the UV lights or lamps may be connected to the generator and may receive electrical energy to remain powered and thus provide UV radiation to the turbine, its housing and the components of the turbine. The UV radiation may sterilize the turbine and its housing to the standards required in compliance with the regulatory agency of the country in which the turbine is installed. Various countries may have differing standards for the amounts of microbial agents and contaminants allowed in potable water. The UV radiation supplied to the surfaces of the turbine may adjusted as needed to the necessary sterilization.

In alternative embodiments, one or more low powered, UV emitting LEDs may be used as the UV light or lamp. LEDs may be advantageous because they may require less overall power consumption to operate than a standard UV light or UV lamp and thus may consume less of the overall energy produced by the turbine.

In some embodiments of the system, the turbine may be installed or attached to the pipes of the water distribution piping 110. The turbine may be installed during the new construction of a building or the turbines may be retrofitted to accommodate existing piping. In an embodiment wherein installation during new construction is desired, the network of water distribution pipes 110 may be pre-installed with one or more turbines along a plurality of segments in the piping network. In some embodiments, the turbine may be constructed to include a self-contained turbine housing 501 or protective casing to cover or conceal at least a portion of the turbine and the remaining components of the turbine. Embodiments of the turbine housing 501 may include a first end 513 and a second end 515. Each end 513, 515 of the turbine housing 501 may be configured for attaching to a first pipe or a second pipe of the piping system 110. The first pipe and the second pipe may be in fluid communication with one another. The turbine housing may bridge the connection between the first pipe and second pipe, allowing the first and second pipe to maintain their fluid communication, once the turbine and its housing are installed. In some embodiments, the first pipe and/or second pipe of the piping system may pressurized with water from the potable water source. The housing may be capable of receiving each pipe and may act as a connecting piece between two pipes in the piping network 110 in some embodiments. Some embodiments of the housing 501 may further include adjustable connectors, fittings or adapters that may modify the diameter of the housing 501 openings at either the first end 513 or the second end 515. The adjustable connectors, fittings or adapters may allow for the housing 501 to properly fit and connect with various sized pipes having varying diameters, with a single turbine unit.

In some embodiments, the turbine may be retrofitted for installation in an existing network of water distribution pipes. For example, in some embodiments, existing water pipes may be cut or severed, producing a first end 510 of the pipe and a second end 512 of the pipe. The housing 501 of turbine may be adjusted or sized to accommodate the first end 510 and the second end 512 of the pipe 110 accordingly to ensure a proper attachment and/or form a water-tight seal. In the exemplary embodiment depicted in FIG. 5, the first end 510 of the pipe 110 may be inserted into the first end of the turbine housing 513. Subsequently, the second end of the 512 of the pipe may be inserted or connected with the second end 515 of the turbine housing. Once the turbine housing is properly attached to the first and second end of the pipe 110, the water may flow from the first or second end of the pipe 110 into the turbine and exit the opposite end into the opposing pipe in the piping network 110.

In an alternative embodiment, one or more of the pipes 110 being retrofitted with a turbine may simply be disconnected at a joint or connection point between two or more pipes, instead of physically severing a single pipe into two portions. For example, a contractor or plumber may identify a joint or connecting piece of plumbing attaching two separate pieces of piping. The turbine housing 501 may act in some embodiments as a replacement for the joint or connector, allowing a first pipe and second pipe to connect together in fluid communication via the turbine and the turbine housing. The turbine housing may receive the first pipe at the first opening end of the housing 513 and subsequently connect the second pipe at the second opening end 513.

In alternative embodiments, the turbine and turbine housing 501 may be manufactured at the appropriate size to be mounted directly inside the piping 110, instead of connecting a plurality of pipes or pieces sections together. For example, in some embodiments, the turbine 500 or turbine housing 501 may be directly attached, connected, adhered, or welded to the interior surface of the pipe 110. In other embodiments, the interior surface of the pipe 110 may be outfitted with one or more hangers, adapters, collars, inserts or a subsequent fastening apparatus for indirectly mounting the turbine inside the pipe 110. In alternative embodiments, the water distribution pipe may act as cover or housing for the turbine housing, allowing for the water distribution pipe to conceal the turbine inside it.

Embodiments having a directly or indirectly mounted turbine attached to the interior surface of the pipe 110, may include shaft 505, at least one blade, generator 507, at least a portion of the wires or electrical conduits 509,511, or a combination of turbine components thereof present inside the confines of the pipe 110. In some embodiments, the exterior surface of the pipe 110 may replace the turbine housing 501 and provide a similar function as the turbine housing to protect the components of the turbine. In an alternative embodiment, one or more components of the turbine may be present inside the interior of the pipe, while one or more turbine components may reside outside of the interior portion of the pipe. For example, in one embodiment, one or more blades 503 of the turbine 500 may reside within the interior of the pipe 110. In addition, a portion of the shaft may extend through the interior portion of the pipe 110 and the exterior surface thereof. The shaft may connect the blades residing inside the pipe 110 to the generator which may reside externally to the pipe.

Embodiments of a method for generating hydroelectric power using the embodiments of the system described above, may include the step of providing at least one pump 109, 409 wherein the at least one pump is receiving water from a water source 105. In some embodiments, the water source may be a potable source of water. In other embodiments, the water source may not be potable or suitable for consumption, such as a waste line or recycled, yet unpurified water. In some embodiments, the method for generating hydroelectric power may further include the steps of connecting a transport pipe 107 to pump 109, 409, releasing the water from the water source 105 and transporting the water from the water source 105 to a fluid inlet or input on the pump 109, 409 via the transport pipe 107.

In some embodiments of the method for generating hydroelectric power, the method may further include the steps of connecting a water distribution pipe to the water discharge or outlet portion of the at least one pump 109, 409. The pump 109, 409 may proceed in pressurizing, discharging and/or releasing the water received via the fluid inlet or input from the pump to the attached water distribution pipe via the discharge or outlet portion of the pump. Embodiments of this method may further include the step of installing one or more turbines along the water distribution pipe. Said turbine may include at least one blade, a shaft and a generator. In some embodiments, the step of installing may include placing or connecting the turbine or turbine housing between a first pipe and a second pipe. In some embodiments, the step of installing the turbine may be performed during the steps of constructing the building 101.

In other embodiments, the step of installing the turbine may be performed by retrofitting the turbine to fit existing water distribution pipes 110. Embodiments of the step of retrofitting the water distribution pipes for installation of the turbine may include the step of severing a water distribution pipe into two or more segments, including a first end 510 and a second end 512. Subsequently after severing the pipe, a contractor, plumber or other user may proceed in attaching the first end of the turbine housing 513 to the first end 510 of the pipe 110 and the second end of the pipe 512 to the second end of the turbine housing 515. In alternative embodiments, the method may include installing or attaching the turbine within an interior portion of the distribution pipe.

Embodiments for generating hydroelectric power may further include the step of rotating the shaft and at least one blade of the turbine. As the discharged water flows through the water distribution pipe, the flowing water may proceed by rotating the shaft and at least one blade of the turbine. This step of rotating the blades and shaft may successfully proceed in producing mechanical energy. Subsequently, the generator of the turbine may proceed to produce electrical energy by converting the mechanical energy of the rotating blades into electrical energy.

In some embodiments of the method for generating hydroelectric power, the method may further include the step of transporting the electrical energy to at least one storage battery and/or transporting at least a portion of the electrical energy to a power supply providing electrical energy to the building 101. The step of transporting the electrical energy may be regulated by the charging controller or the elements of the battery bank circuit described above.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for generating hydroelectric power comprising the steps of:
providing a pump receiving a potable water source;
connecting a water distribution pipe to the pump;
discharging from the pump, a portion of the potable water source into the water distribution pipe;
installing a turbine along the water distribution pipe, wherein the turbine includes at least one blade, a shaft and a generator;
rotating the shaft and at least one blade of the turbine, producing mechanical energy; and
converting the mechanical energy into electrical energy using the generator.

2. The method of claim 1, further comprising the step of transporting the electrical energy to at least one storage battery.

3. The method of claim 1, wherein the pump is a constant speed pump or a variable speed pump.

4. The method of claim 1, wherein the step of installing the turbine includes the step of retrofitting the water distribution pipe to a housing of the turbine.

5. The method of claim 4, wherein the step of retrofitting includes a step of severing the water distribution pipe into a first end and a second end, wherein the housing of the turbine attaches between the first end and second end of the water distribution pipe.

6. The method of claim 1, wherein the turbine is a reaction turbine, a propeller turbine, a Francis turbine or a kinetic energy turbine.

7. The method of claim 6, wherein the propeller turbine is a bulb turbine, a Straflo turbine, a tube turbine or a Kaplan turbine.

8. A system for generating hydroelectric power comprising:
a pump placed in fluid communication with a source of potable water, wherein the pump includes a fluid discharge output;
a water distribution pipe connected to the fluid discharge output of the pump;
a turbine having at least one rotatable blade connected to a shaft; and
a turbine housing concealing at least a portion of the turbine, connected to the water distribution pipe.

9. The system of claim 8, wherein the turbine is further includes a generator attached to the shaft, wherein said generator is further placed in electrical communication with at least one battery.

10. The system of claim 8, wherein the at least one pump is a constant speed pump or a variable speed pump.

11. The system of claim 8, wherein the water distribution pipe is the turbine housing, such that the water distribution pipe conceals the turbine inside the water distribution pipe.

12. The system of claim 8, wherein the turbine housing attaches between a first end of the water distribution pipe and a second end of the water distribution pipe.

13. The system of claim 8, wherein the turbine is a reaction turbine is a propeller turbine, a Francis turbine or a kinetic energy turbine.

14. The system of claim 13, wherein the propeller turbine is a bulb turbine, a Straflo turbine, a tube turbine or a Kaplan turbine.

15. The system of claim 8, wherein the turbine produces electrical power that is approximately 10-100% of the electrical power consumed by the at least one pump.

16. An apparatus for generating hydroelectric power comprising:
a turbine including a turbine housing, said turbine housing encloses a rotatable shaft operably connected to one or more rotatable blades and a generator, wherein the turbine housing includes a first end and a second end, wherein the first end connects to a first pipe pressurized with potable water and the second end connects to a second pipe in fluid communication with the pressurized potable water of the first pipe.

17. The apparatus of claim 16, wherein the first end and the second end of the turbine housing each include an adjustable connector, sized to fit the first pipe and second pipe.

18. The apparatus of claim 16, wherein the turbine is pre-sterilized.

19. The apparatus of claim 16, wherein the apparatus further includes one or more UV generating lights affixed to the apparatus, wherein the UV generating lights receive electrical power from the generator.

20. The apparatus of claim 19, wherein the UV generating lights are LEDs.
